(19) United States
(12) Patent Application Publication
(10) Pub. No.: US 2008/0091281 A1
(43) Pub. Date: Apr. 17, 2008

(54) Method for the Monitoring and Control of a Process

(75) Inventors: Derek Alan Colman, Hampshire (GB); James Adam Townsend, London (GB)

Correspondence Address: NIXON & VANDERHYE, PC, 901 NORTH GLEBE ROAD, 11TH FLOOR, ARLINGTON, VA, 22203, US

(73) Assignees: BP CHEMICALS LIMITED, Middlesex (GB); BP OIL INTERNATIONAL LIMITED, Middlesex (GB)

(21) Appl. No.: 11/597,836

(22) PCT Filed: Jun. 2, 2005
(86) PCT No.: PCT/GB05/02177

§ 371 Date: Nov. 13, 2007

(30) Foreign Application Priority Data
Jun. 7, 2004 (GB) 0412672.8

(51) Int. Cl. G05B 13/00

(52) U.S. Cl. 700/29

(57) ABSTRACT

A method for process control, said method comprising: (a) providing a computational fluid dynamics model of a first process, (b) inputting to the computational fluid dynamics model data on the feed to said first process, said data representing the situation at an initial time t⁰, such that the model generates a real-time simulation of one or more properties of said first process at a future time, t², and (c) using the simulation for control of said first process or for control of a second process to which the first process is linked.

This invention relates to a method for the monitoring and control of a process using computational fluid dynamics.

Computational fluid dynamics (CFD) is a well-known tool for modelling fluid flow, by utilising computational methods to solve the momentum and mass conservation equations governing fluid flow. For example, CFD may be used to model fluid flows when designing mixing vessels to ensure that suitable mixing will be achieved. Similarly, when designing reaction vessels CFD may be used to ensure that optimum contact of reactants with each other and/or with any catalyst that may be present will be achieved by the reactor design.

CFD computes the flow structure and characteristics of a system given the system boundary conditions and using the fundamental equations of flow of continuous media namely the conservation equations of mass and momentum (otherwise known as the Navier Stokes Equations). CFD may be run in either a steady or unsteady (time dependent) mode. The technique makes no a priori assumption about the final solution and requires no further input of data other than the initial boundary conditions (for example, it does not require the measurement of a pressure drop to derive the solution). To put it another way, the technique computes the required properties of a system at a time t¹ given the system boundary conditions at an earlier time t⁰.

In some, simple, flow problems (such as 2D inviscid flows) the flow can be

computed analytically, however, in most engineering flows of practical interest the non-linear second order differential equations need to be solved numerically. CFD does this by dividing the flow regime into many small cells (typically>100 k) and numerically solving the equations in each cell iterating the prediction until a solution is obtained.

CFD is described, for example, in “Computational Fluid Mixing”, by E. M. Marshall and A. Bakker, published by Fluent-inc, 2002.

Typically, CFD modelling has taken many hours or even days of computer time, even for fairly simple systems, particularly When these are time dependent solutions. Nevertheless, despite the time required for calculations, CFD has proven a valuable tool for designing mixing and/or reaction vessels, where the calculation time is not critical.

Prior to the making of the present invention, CFD models making no a priori assumptions about the system other than the initial boundary conditions, have never been used for real-time process control. EP 398706 describes a method of predicting the physical properties of a polymer formed from a plurality of monomers in a reactor, and states that the results can be used to alert the operator of unusual reactor problems. However, the method described requires the input of real process data (i.e. the results of previously carrying out the process) having been measured at various points in the reactor (and hence at a time t⁰), and the results of the calculation give estimates of a different parameter but at the same time t⁰ that the initial data was measured.

We have now found that computational fluid dynamics, particularly when run in unsteady (time dependent) mode, can be applied to real-time process monitoring to give improved process control.

Thus, according to a first aspect, the present invention provides a method for process control, said method comprising:
(a) providing a computational fluid dynamics model of a first process,
(b) inputting to the computational fluid dynamics model data on the feed to said first process, said data representing the situation at an initial time t⁰, such that the model generates a real-time simulation of one or more properties of said first process at a future time, t¹, and
(c) using the simulation for control of said first process or for control of a second process to which the first process is linked.

By “real-time simulation” is meant a simulation from which the simulation output (simulation result) is available in a time period short enough to enable the process conditions to be predicted as, or faster than, they happen and thus controlled as necessary in response to the output; i.e. from data applicable at an initial time t⁰, the system is capable of calculating a property at a later time t¹ and, if necessary, using that calculation to control the process (or a second process) at or before time t¹.

The method of the invention may be implemented by means of a control system, and therefore according to a further embodiment of the invention, there is provided a control system for a process, which comprises:
(a) a computer programmed to run a computational fluid dynamics model of a first process,
(b) ail input system for inputting to the computational fluid dynamics model, data on the feed to said first process, said data representing the situation at an initial time t⁰, such that the model generates a real-time simulation of one or more properties of said first process at a future time t¹, and
(c) a controller responsive to said simulation and adapted to use said simulation for control of said first process or for control of a second process to which the first process is linked.

The control system according to the invention operates in such a way that the controller (c) which, as described below, may be an automated process control system or may be operated by an operator, is capable of being exercised at or before time t¹.

Preferably, the controller (c) controls a second process to which the first process is linked, and said first process is a mixing process in a suitable mixing vessel which has an outlet stream which is taken as a feed to said second process. For example, the mixing vessel may be a crude oil storage tank and the second process may be a crude distillation unit. Further details of this embodiment are given below.

In order to generate a real-time simulation of one or more properties of said first process at a future time t¹, the data on the feed must relate to the feed into the first process at a time t⁰ which is up to the time t¹, and may include, for example, feed rate and composition for all feed streams to be fed to the first process up to this time. The composition of streams to be fed to a process may be obtained, for example, from analysis in suitable feed storage tanks or in upstream pipework, such as from flowmeters, at a time sufficiently before said streams enter the process. This data may be input to the CFD model either by an operator or by an automated feed monitoring system. The input to the CFD model may itself be the results of a model or simulation, such as the output from a separate CFD model operating on an upstream storage tank.

The present invention has the advantage that the CFD model is used to predict one or more properties of said first process and, where necessary, to act on said output either (i), where the simulation output is used for control of said first process, before the predicted properties occur in said first process, or (ii), where the simulation output is used for control of a second process to which the first process is linked, before the predicted properties have effect in said second process.

The control of said first or second process in response to the CFD model prediction is typically performed by an operator or by an automated process control system. Although the operator or automated control system may “use” the simulation output to change tie conditions of the first or second process, it may equally be that the simulation output may be “used” as an assurance that the first or second process will operate acceptably under the predicted conditions, and no changes are necessary.

The simulation can also be used to generate a real-time simulation of one or more properties of said first process for subsequent times t², t³ etc. This may be achieved by running the simulation continuously or by re-running (repeating) the simulation on a regular basis to generate a simulation at a series of future times, t², t³, etc. In this way the present invention can give process monitoring and control with time.

By running “continuously” is meant that the simulation continually updates, such that once the simulation output at a time t¹ has been generated, the simulation continues, to generate the simulation output for a subsequent time t². Thus, the simulation at time t¹ may be updated to generate a real-time simulation of one or more properties of said first process at a future time, t², which is after t¹, by updating the simulation for time t¹ with data on the feed to said first process between times t¹ and t². In this embodiment the simulation runs on the same time period as the updates (difference in time between t² and t¹) i.e. where the simulation takes ten seconds to run, the times t² and t¹ should be ten seconds apart.

Alternatively, the simulation may be run (re-run) to generate a real-time simulation of one or more properties of said first process at future times, t²,t³ etc., which are after t¹, by running separate real-time simulations for each. Typically, each is started after the previous simulation has run, although it is possible for simulations to be started before the previous simulation and have simulations run in parallel. For example, the simulation can be run to generate a real-time simulation of one or more properties of said first process at a future time, t², which is after t¹, by using actual (i.e. measured) data on the first process at a time t and data on the feed to said first process between times t and t². Where each simulation is started after the previous simulation has run, each simulation runs on a time period which is less than that for the updates (difference in time between t² and t¹) i.e. where the simulation takes ten seconds to run, the times t² and t¹ should be at least ten seconds apart, to allow the subsequent simulation to start and complete in time.

A combination of the above may also be used. For example, a simulation may be run continuously using initial data at t⁰ and continually updating the simulation for subsequent time periods over an overall period, such as 1 hour, followed by restarting the simulation using a new set of initial data, which may be derived from actual measurements. Effectively, time t¹ is reset to represent a new time t⁰. In this way, the new data provides a control of the continuously running simulations, and ensures that the continuously running simulations do not become unrepresentative of actual conditions.

The simulation is preferably run or updated on a regular basis, such as on a time period from every 1 second to every 60 minutes (i.e. t³-t², t²-t¹ etc.).

All simulation outputs may be used for control of said first or second process, or the control may use only simulation outputs separated by a longer time scale. For example, where the simulation is repeated every 10 seconds, it may only be necessary to use one of the outputs every minute or every 10 minutes for the process control. Thus, the time period of the simulation may be less than the update time step used for process control, depending upon the required resolution of the control model.

The time step used in the computation is not necessarily a constant time step and may be varied within the model according to the rate of change of variable in order to optimise the computational time.

The “one or more properties” of said first process may include chemical and/or physical properties. Typical chemical properties include chemical composition. Typical physical properties include, for example, density and viscosity. Properties may also include the concentration of a dispersed or second phase, such as water in oil.

The CFD model will generate a “property map” (or one or more property maps) which shows how the one or more properties vary within the first process, for example, a map of the concentration of a chemical reagent within a reaction vessel, or a map of the density of a fluid or component composition within a mixing vessel.

In a first aspect of the present invention, the first process is a reaction in a suitable reaction vessel.

In a preferred embodiment of this first aspect, the output of the simulation is a map of the compositional variation within the reaction vessel and is used for control of said reaction. The output of the simulation may also include, for example, the temperature and pressure values within the reaction vessel. The output may also include the properties of the stream exiting the vessel. Since said output is used for control of said reaction, it should be available to the operator or the automated process control system before the actual conditions occur in the reaction vessel, such that, if any undesired conditions are predicted, the operator or control system may respond to prevent their occurrence.

Undesired conditions may include for example, regions within the reaction vessel which are outside of safe flammable or explosive limits, which have too low or too high a concentration of one or more reactants or of catalyst, have unsuitable flow properties, such as static regions, and/or which may form hot- or cold-spots.

Alternatively, or additionally, having the output from the simulation before the actual conditions occur in the reaction vessel may allow the operator or process control system to optimise the reaction conditions for any changes in the feed.

In this first aspect, the data on the feed may include, for example, feed rate and composition for all feed streams, including any recycle streams. For example, the composition of “fresh” feed streams can be obtained from analysis in suitable feed storage tanks or in upstream pipework at a time sufficiently before said streams enter the reaction vessel, and the composition of any recycle streams may be obtained from analysis of the recycle stream in the recycle loop at a time sufficiently before said stream re-enters the reaction vessel. Alternatively, the composition of any recycle streams may be obtained from the simulation output itself.

In this first aspect, the input to the CFD model may also include data on other 30 process variables, such as catalyst activity, including any changes due to, for example, deactivation or addition of fresh catalyst, where applicable, and temperature and pressure conditions. For example, catalyst activity may be based on predicted deactivation rates and/or planned introductions of fresh catalyst, and catalyst temperature and pressure can be based on planed or predicted changes in the process conditions, such as increases in temperature to off-set catalyst deactivation.

In a second, and preferred, aspect, the first process is a mixing process in a 5 suitable mixing vessel. In a preferred embodiment of this second aspect, the mixing vessel has an outlet stream which is taken as a feed to a second process, the conditions of which can be optimised based on the composition of the outlet stream. In this instance, the output of the simulation should be available to an operator or automated process control system for the second process before the outlet stream of said composition reaches the second process, such that the operator or process control system can optimise the second process for the outlet stream when it “arrives” at said second process.

An example of the second aspect of the present invention comprises, as the mixing vessel, a crude oil storage tank and, as the second process, a crude distillation unit.

Crude distillation units are an integral part of a crude oil refinery. Said units are fed with crude oil from one or more crude oil storage tanks, which, in turn, are fed with batches of crude oil, for example from a tanker or pipeline. There are typically several crude oil storage tanks for a single crude distillation unit.

Each crude oil storage tank may typically have a capacity of up to 100,000 m³. Crude oil from a crude oil storage tank is fed as to the crude distillation unit, optionally after pre-treatment, for example in a crude oil desalter. However, it is usually not possible to empty a crude oil storage tank completely, and, in some instances, crude oil with a volume of up to 20% of the maximum capacity of the tank is maintained in the crude oil storage tank. The tank is then refilled, for example, from a crude oil tanker. Since crude oils can vary considerably in both their chemical properties, such as hydrocarbon composition and water content, and in their physical properties, such as viscosity and density, the overall and local properties of the crude oil in the tank will depend on the relative volumes and properties of the residual crude oil in the tank and the “fresh” crude oil.

The properties of the crude oil are important since crude oil distillation columns can be optimised based on them. Traditionally, it has been assumed that complete mixing of the residual and “fresh” crudes occurs in the crude oil storage tank to give a homogeneous composition. Despite these assumptions, even when mixing is employed in the crude oil storage tank, the composition can vary within the tank. Hence, when the crude is passed to a crude distillation column the properties from the crude oil can vary with time, and the distillation will be sub-optimum.

In the process of the present invention, the properties of the “fresh” crude oil, such as total volume, flow rate, chemical composition, density and viscosity, are input to the CFD model of the crude oil storage tank. The CFD model already contains details of the residual crude oil in the tank (from simulations based on earlier filling and emptying of the crude oil storage tank), and calculates the properties of the crude oil as a function of the position within the tank. This “property map” is updated regularly, such as every few minutes to every hour, for example, as further “fresh” crude oil is added with time (it may take 24 hours or longer to empty a crude oil tanker into a crude oil storage tank), or due to mixing (which occurs even once the filling has been completed and as the crude oil is removed from the tank). Mixing in the tank may be from side entry mixers and models, for these and their effect can be included in the CFD model.

The model will simulate the “property map” of the crude oil within the crude oil storage tank at the time the crude oil is to be discharged and as it is fed to the crude distillation unit, and also during the subsequent feeding from the crude oil storage tank, and hence can predict the variation of the crude oil fed to the crude distillation unit with time.

This gives the opportunity for the crude distillation unit to be regularly optimised based on the variation in crude oil properties with time. For example, if at time t⁰ it is known that a certain fluid is to be pumped into a tank for x hours at a given flow then CFD may be used to predict, in less than x hours, what the state of the mixture in the tank will be at the end of the x hours. This has not previously been achieved with, or expected of, CFD. In the method of the present invention, no further measurements of the state of the tank or adjustments to the model are made beyond the initial data input. This is in contrast to the process of EP 398706, in which a computational technique is used to calculate one characteristic of the system at a time to (specifically, number average and weight average molecular weights) given the measured values of another characteristic (e.g. the pressure drop) at that same time t⁰. Thus, the method of EP 398706 cannot predict the required condition until the event has actually happened and a measurement has been taken.

Although the above has been described with respect to a “batch-type” operation, where the crude oil storage tank is “emptied” and refilled in batches, continuous or semi-continuous operation is also possible, where the crude oil tank is having crude oil fed to it, whilst feeding crude oil out to a crude distillation unit simultaneously, and the present invention can also be utilised for this type of operation.

In a most preferred embodiment of the present invention, two, and optionally more, computational fluid dynamics models are run in parallel.

In this embodiment, a first model provides a record of the actual contents and performance of the first process at a particular time, and a second model is used for simulation and control. The first model takes input data from the actual plant control system and models the conditions within the first process as close as possible to “actual” time i.e. as they are occurring. This first model is not used directly for any control purposes, but may be used as an input for the second (predictive) model, which is described further below. The first model may also be used as a “quality control” model to monitor the accuracy of the predicted outputs from the second model. The first and second models may be refined further based on the learning from any differences.

The second model is used for simulation and control, and is input with the current properties, preferably based on the current properties from the first model, and the data on the feed. From this information, the second model generates a real-time simulation of the one or more properties of said first process, and uses the simulation output for control of said first process or for control of a second process to which the first process is linked, as previously described.

The CFD simulation may link to other simulation models for carrying out specific property calculations, for example, it may link to a thermodynamic and reaction model to predict physical properties and compositions.

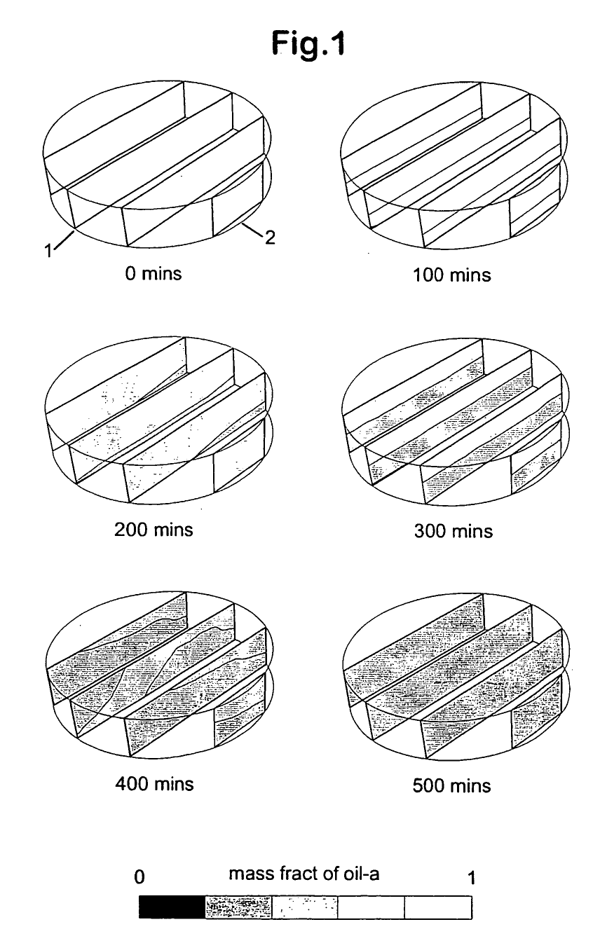

The invention will now be illustrated with respect to FIG. 1 and the following Example.

FIG. 1 represents the mixing of crude oils in a storage tank as further crude oil is added. The storage tank has an inlet, 1, positioned near to the base of the tank and directed radially across the tank, and an outlet, 2, also positioned at near to the base of the tank and at 90 degrees from the inlet.

### EXAMPLE 1

The computational fluid dynamics model is a 3D time dependent simulation of mixing in a large storage tank using Fluent version 6.1 as the CFD code.

The storage tank is as described above for FIG. 1, has a diameter of 80 m and height of 17 m, and for the purpose of this simulation it is assumed that the feed flow is equal to the outlet flow such that the storage tank remains full. (If required the surface of the liquid could be allowed to rise and fall as the tank is filled and emptied by adaption of the computational grid)

The inlet of the storage tank is of 0.6 m diameter, and the outlet is also 0.6 m diameter.

Mixing in the tank is effected by the inlet jet.

The computational grid comprises 96000 cells of nominal size 1 m³ across the majority of the tank, but smaller cells were used around the inlet and outlet.

The model was run continuously and an updated simulation generated every 10 secs.

The storage tank was initially filled only with oil-a, which has a viscosity of 10 centipoises (cP) and a specific gravity (SG) of 0.8. At time t=0 oil-c, which has a viscosity of 400 cP and a specific gravity of 0.9, was introduced into the tank, via inlet 1, at a velocity of 10 m/s (equivalent to approx. 2500 kg/s). After 330 minutes, the flow of oil-c was stopped, and oil-a was introduced into the tank, via inlet 1, at a velocity of 10 m/s.

FIG. 1 shows the results obtained for the storage tank composition with time in 100 minute steps.

At time zero, the storage tank comprises only oil-a. Oil-c is then introduced via the inlet, 1, and over the time periods shown by 100 min, 200 min and 300 min, the composition within the storage tank varies to represent an increasing average mass fraction of oil-c. However, it is apparent from FIG. 1 that the mixing is not uniform, and that higher concentration regions of oil-c in oil-a exist. At time t=400 mins, oil-a has been introduced as the inlet feed, and again significant non-uniformity in the mixing within the tank is observed.

This non-uniformity is also apparent from Table 1, below, which shows the average concentration of Oil-a in the tank, and the actual concentration at the outlet, 2, based on the simulation in FIG. 1.

TABLE 1

| Time | Average concentration | Actual concentration of |
|---|---|---|
| (mins) | of Oil-a | Oil-a at tank outlet, 2. |
| 0 | 1 | 1 |
| 100 | 0.82 | 0.74 |
| 200 | 0.68 | 0.60 |
| 300 | 0.57 | 0.50 |
| 400 | 0.56 | 0.58 |
| 500 | 0.67 | 0.66 |

As shown in Table 1, these simulation results allow the composition at the outlet, 2, to be calculated with time and in “real-time” such that subsequent process steps in a second process to which the mixed crude oil from the outlet is fed, such as a crude distillation unit, can be controlled, if necessary, in response thereto before the crude oil reaches said second process.

1. A method for process control, said method comprising:
(a) providing a computational fluid dynamics model of a first process,
(b) inputting to the computational fluid dynamics model data on the feed to said first process, said data representing the situation at an initial time t⁰, such that the model generates a real-time simulation of one or more properties of said first process at a future time, t¹, and
(c) using the simulation for control of said first process or for control of a second process to which the first process is linked.

2. A method according to claim 1, wherein the simulation is run continuously or repeatedly to generate a real-time simulation of one or more properties of said first process for subsequent times t², t³ etc., and to give process monitoring and control with time.

3. A method according to claim 1, wherein the one or more properties of said first process include one or more of chemical composition, density and viscosity.

4. A method according to claim 1 wherein the simulation is used for control of said first process, and said first process is a reaction in a suitable reaction vessel.

5. A method according to claim 1 wherein the simulation is used for control of a second process to which the first process is linked, and said first process is a mixing process in a suitable mixing vessel which has an outlet stream which is taken as a feed to said second process.

6. A method according to claim 5, wherein the mixing vessel is a crude oil storage tank and the second process is a crude distillation unit.

7. A control system for a process, which comprises:
(a) computer programmed to run a computational fluid dynamics model of a first process,
(b) an input system for inputting to the computational fluid dynamics model, data on the feed to said first process, said data representing the situation at an initial time t⁰, such that the model generates a real-time simulation of one or more properties of said first process at a future time t¹, and
(c) a controller responsive to said simulation and adapted to use said simulation for control of said first process or for control of a second process to which the first process is linked.

8. A control system according to claim 7, in which the controller (c) controls a second process to which the first process is linked, and said first process is a mixing process in a suitable mixing vessel which has an outlet stream which is taken as a feed to said second process.

9. A control system according to claim 8, wherein the mixing vessel is a crude oil storage tank and the second process is a crude distillation unit.
